(19) United States
(12) Patent Application Publication
(10) Pub. No.: US 2024/0005088 A1
(43) Pub. Date: Jan. 4, 2024

(54) SYSTEM AND METHOD FOR CONSOLIDATION AND AUTOMATED DISTRIBUTION OF INFORMATION

(71) Applicants: Steven L. Weiner, Alamo, CA (US); Jordan Weiner, Alamo, CA (US)

(72) Inventors: Steven L. Weiner, Alamo, CA (US); Jordan Weiner, Alamo, CA (US)

(21) Appl. No.: 18/160,477

(22) Filed: Jan. 27, 2023

Related U.S. Application Data
(60) Provisional application No. 63/303,870, filed on Jan. 27, 2022.

(51) Int. Cl. G06F 40/174

(52) U.S. Cl. CPC G06F 40/174

(57) ABSTRACT

A system comprising first memory adapted and configured to store information and data regarding a user in a plurality of first data fields, communications components adapted and configured to interface with a plurality of alternate systems having second data fields corresponding to said first data fields, for performing the steps of identifying relationships between said first data fields and said second data fields and automatically propagating data from said first data fields to said second data fields up receipt of a user request.

### CROSS-REFERENCE TO RELATED APPLICATIONS

The present application claims the benefit of priority to prior-filed and co-pending U.S. Provisional Patent Application No. 63/303,870, filed Jan. 27, 2022 by Steven L. Weiner and Jordan Weiner, the complete contents of which is hereby incorporated herein by reference.

### BACKGROUND

### Technical Field

The present device relates to the field of data aggregation and distribution and more specifically to a system and method of consolidation and automated distribution of information.

### Background

Many services and applications, such as dating sites/services, require the entry of similar information. Moreover each site/service are pay services and management of the data on the sites/services and payment of the associated fees can be expensive and/or time consuming. What is needed is a system and method for consolidation and automated distribution of information and/or service management.

### BRIEF DESCRIPTION OF THE DRAWINGS

Further details of the present device are explained with the help of the attached drawings in which:

FIG. 1 depicts an embodiment of a system and method for consolidation and automated distribution of information and/or service management.

FIG. 2 depicts an embodiment of a feature of a user interface.

FIG. 3 depicts an embodiment of a feature of a user interface.

FIG. 4 depicts an embodiment of a data mapping schema.

FIG. 5 depicts an embodiment of a computer system for implementation of a system and method for consolidation and automated distribution of information and/or service management.

FIG. 6 depicts an embodiment of the system and method for consolidation and automated distribution of information and/or service management.

FIG. 7 depicts an embodiment of a system of user interaction.

FIG. 8 depicts an embodiment of a system and method of user interaction.

FIG. 9 depicts an embodiment of a system and method of user interaction.

FIG. 10 depicts an embodiment of a system and method of administrative user interaction.

FIG. 11 depicts an embodiment of a user interface.

FIG. 12 depicts an embodiment of a user interface.

FIG. 13 depicts an embodiment of a system and method of user interaction.

FIG. 14 depicts an embodiment of a user interface.

FIG. 15 depicts an embodiment of a user interface.

FIG. 16 depicts an embodiment of a user interface.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

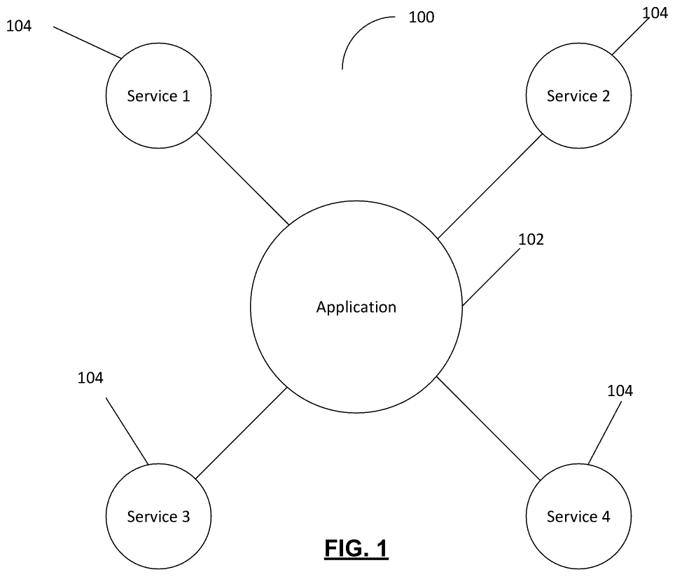

FIG. 1 depicts an embodiment of a system and method for consolidation and automated distribution of information and/or service management 100. In the embodiment depicted in FIG. 1, the system and method comprise a user-controlled application 102 and a plurality of alternate services/applications 104 in communication with user-controlled application 102. In operation, a user can provide and/or update data in the user-controlled application 102 and such data can be selectively updated in one or more of the plurality of alternate services/applications 104. In some embodiments, the data can be whether to continue an association and/or membership with an alternate service/application 104 and/or can be an update in data provided to an alternate service/application 104.

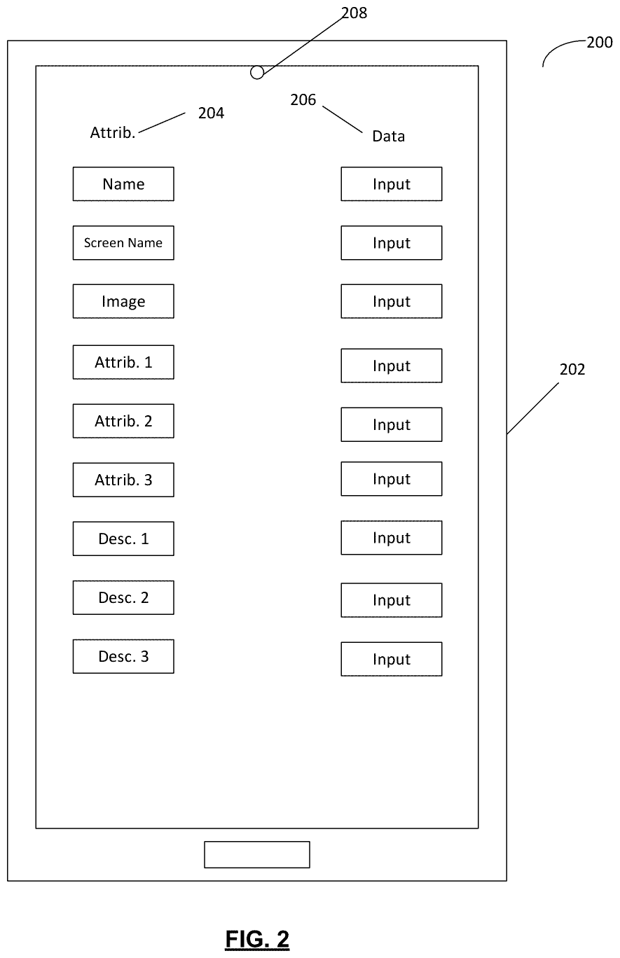

FIG. 2 depicts an embodiment of a feature of a user interface 200. In the embodiment depicted in FIG. 2, the user interface 200 can be implemented on a mobile device 202, such as a telephone and/or tablet computing device. However, in alternate embodiments, the user interface 200 can be implemented on any known, convenient and/or desired computing device. In operation, the user interface can be comprised of a plurality of attributes 204 and associated data fields 206 in which a user can input or update information associated with a particular attribute. In some embodiments, attributes and input can be associated with a specific alternate service/application 104. However, in some embodiments, attributes and the associated input can be general entries which can be associated with specific attributes of alternate services/applications 104. In operation, a user can complete input fields 206 and the information can be stored in association with the associated attributes 204. In some embodiments, the mobile device 202 can be equipped with one or more cameras 208 enabling a user to store and/or capture still images or video for input into the associated data fields 206.

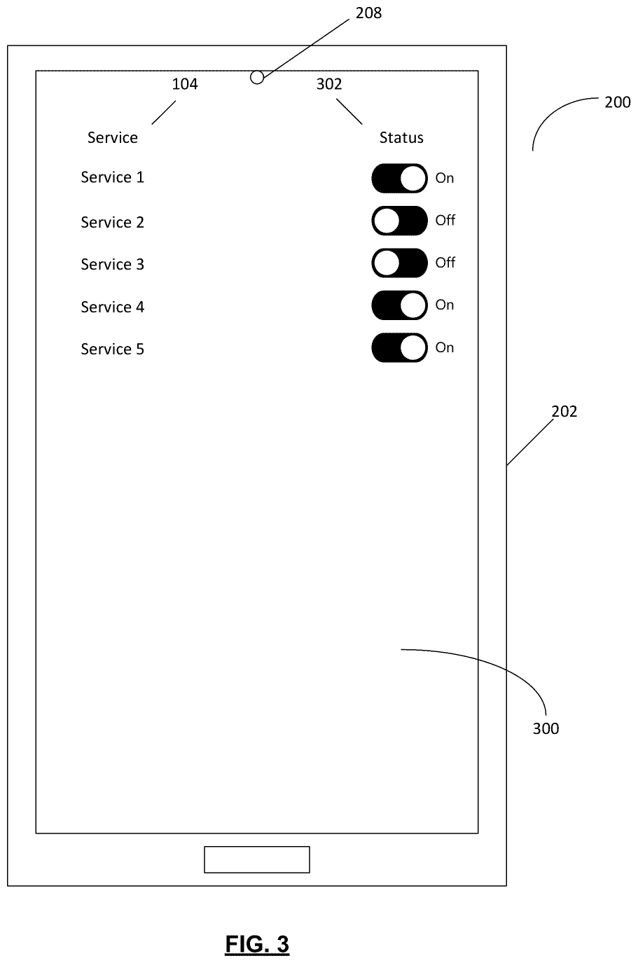

FIG. 3 depicts an embodiment of a feature of a user interface 300. In the embodiment depicted in FIG. 3, a user can selectively identify and/or associated alternate services/applications 104 and selectively modify the status 302 of the association between the system and method for consolidation and automated distribution of information and/or service management 100 and any one or more of the alternate services/applications 104.

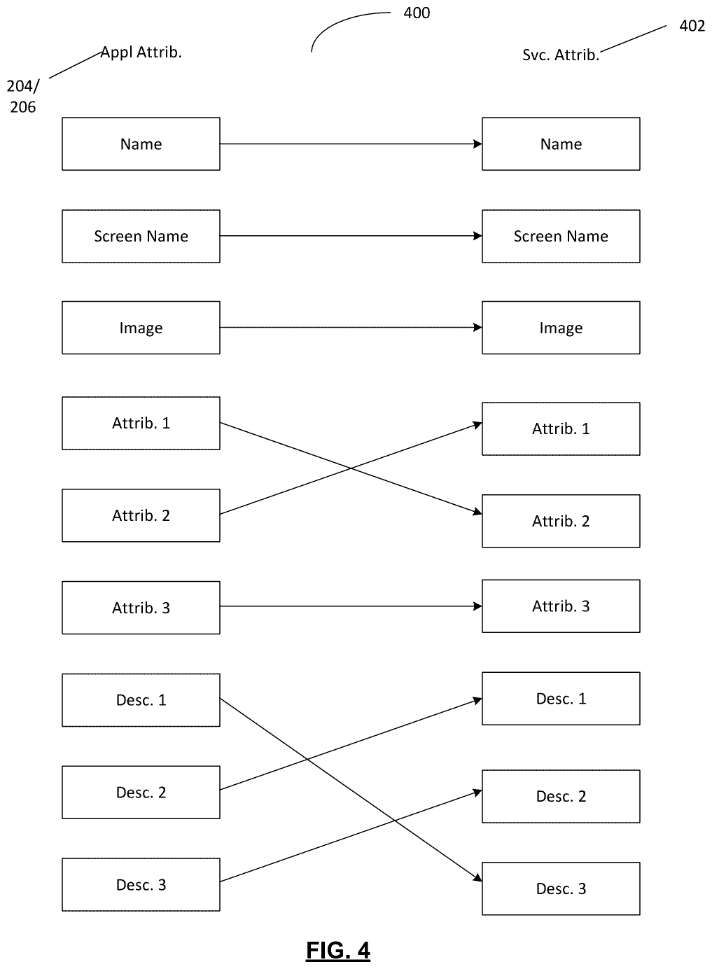

FIG. 4 depicts a non-limiting, exemplary embodiment of a data mapping schema 400. In the embodiment depicted in FIG. 4, the data fields 206 from the user interface 300 can be selectively mapped to data fields 206 associated with attributes and/or fields associated with one or more alternate services/applications 104. In some embodiments, correspondence of the associations can be automatically identified based on names, tags and/or identifiers associated with data fields. However, in alternate embodiments, a user can selectively and changeably identify the association between the user data fields 206 and data fields 402 associated with each alternate service/application 402. In operation, a user can make an update to data 206 associated with a particular attribute 204 and such data can be automatically transmitted to enabled alternate services/applications 402.

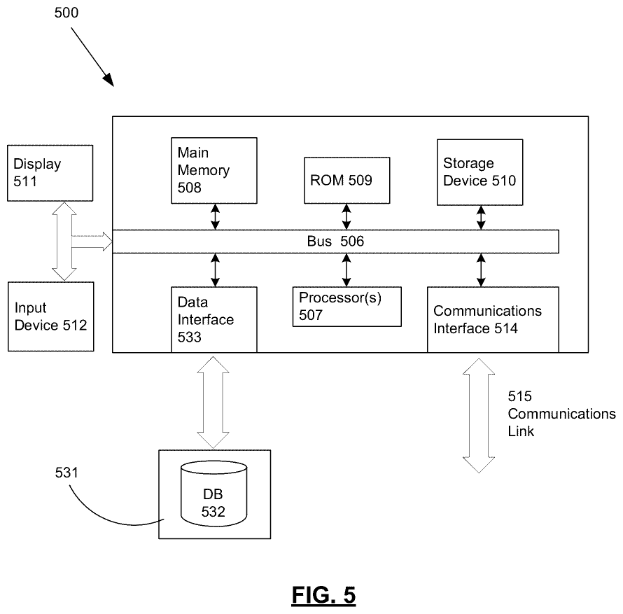

FIG. 5 depicts an embodiment of a computer system for implementation of a system and method for consolidation and automated distribution of information and/or service management. The execution of the sequences of instructions required to practice the embodiments can be performed by a computer system 500 as shown in FIG. 5. In an embodiment, execution of the sequences of instructions is performed by a single computer system 500. According to other embodiments, two or more computer systems 500 coupled by a communication link 515 can perform the sequence of instructions in coordination with one another. Although a description of only one computer system 500 will be presented below, however, it should be understood that any number of computer systems 500 can be employed to practice the embodiments.

A computer system 500 according to an embodiment will now be described with reference to FIG. 5, which is a block diagram of the functional components of a computer system 500. As used herein, the term computer system 500 is broadly used to describe any computing device that can store and independently run one or more programs.

Each computer system 500 can include a communication interface 514 coupled to the bus 506. The communication interface 514 provides two-way communication between computer systems 500. The communication interface 514 of a respective computer system 500 transmits and receives electrical, electromagnetic or optical signals, that include data streams representing various types of signal information, e.g., instructions, messages and data. A communication link 515 links one computer system 500 with another computer system 500. For example, the communication link 515 can be a LAN, in which case the communication interface 514 can be a LAN card, or the communication link 515 can be a PSTN, in which case the communication interface 514 can be an integrated services digital network (ISDN) card or a modem, or the communication link 515 can be the Internet, in which case the communication interface 514 can be a dial-up, cable or wireless modem.

A computer system 500 can transmit and receive messages, data, and instructions, including program, i.e., application, code, through its respective communication link 515 and communication interface 514. Received program code can be executed by the respective processor(s) 507 as it is received, and/or stored in the storage device 510, or other associated non-volatile media, for later execution.

In an embodiment, the computer system 500 operates in conjunction with a data storage system 531, e.g., a data storage system 531 that contains a database 532 that is readily accessible by the computer system 500. The computer system 500 communicates with the data storage system 531 through a data interface 533. A data interface 533, which is coupled to the bus 506, transmits and receives electrical, electromagnetic or optical signals, that include data streams representing various types of signal information, e.g., instructions, messages and data. In embodiments, the functions of the data interface 533 can be performed by the communication interface 514.

Computer system 500 includes a bus 506 or other communication mechanism for communicating instructions, messages and data, collectively, information, and one or more processors 507 coupled with the bus 506 for processing information. Computer system 500 also includes a main memory 508, such as a random-access memory (RAM) or other dynamic storage device, coupled to the bus 506 for storing dynamic data and instructions to be executed by the processor(s) 507. The main memory 508 also can be used for storing temporary data, i.e., variables, or other intermediate information during execution of instructions by the processor(s) 507.

The computer system 500 can further include a read only memory (ROM) 509 or other static storage device coupled to the bus 506 for storing static data and instructions for the processor(s) 507. A storage device 510, such as a magnetic disk or optical disk, can also be provided and coupled to the bus 506 for storing data and instructions for the processor(s) 507.

A computer system 500 can be coupled via the bus 506 to a display device 511, such as, but not limited to, a cathode ray tube (CRT) or a liquid-crystal display (LCD) monitor, for displaying information to a user. An input device 512, e.g., alphanumeric and other keys, is coupled to the bus 506 for communicating information and command selections to the processor(s) 507.

According to one embodiment, an individual computer system 500 performs specific operations by their respective processor(s) 507 executing one or more sequences of one or more instructions contained in the main memory 508. Such instructions can be read into the main memory 508 from another computer-usable medium, such as the ROM 509 or the storage device 510. Execution of the sequences of instructions contained in the main memory 508 causes the processor(s) 507 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 507. Such a medium can take many forms, including, but not limited to, non-volatile, volatile and transmission media. Non-volatile media, i.e., media that can retain information in the absence of power, includes the ROM 509, CD ROM, magnetic tape, and magnetic discs. Volatile media, i.e., media that can not retain information in the absence of power, includes the main memory 508. Transmission media includes coaxial cables, copper wire and fiber optics, including the wires that comprise the bus 506. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high-level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

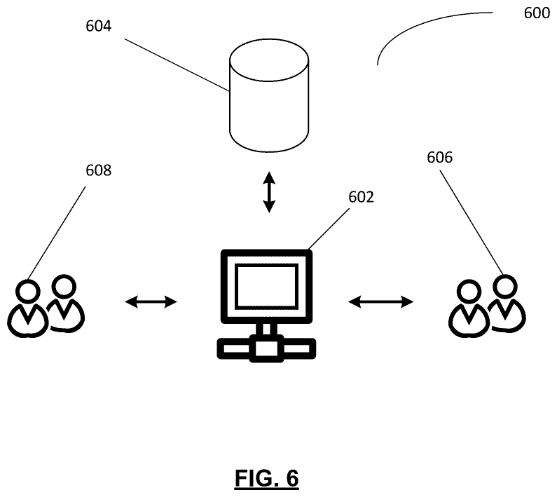

FIG. 6 depicts an embodiment of the system for consolidation and automated distribution of information and/or service management. In the embodiment depicted in FIG. 6, the system 600 comprises a network computing system 602 associated with a database 604. In the embodiment depicted in FIG. 6, users 606 and administrators 608 can interact with the network computing system 602 via user interfaces adapted and configured to receive, configure, store, edit and update data stored in the database 604. In operation, users 606 can enter data to the network computer system 602 and the network computer system 602 can configure the data and update and store the data in a prescribed data structure in the database 604. In some embodiments, administrators 608 can interact with the network computing system 602 to access, view, manipulate or delete data stored in the database 604. In some embodiments, the a user 606 can login and create a profile to submit to multiple connected dating apps—the network computing system 602 can access the database 604 and configure the date for submission to one or more dating apps

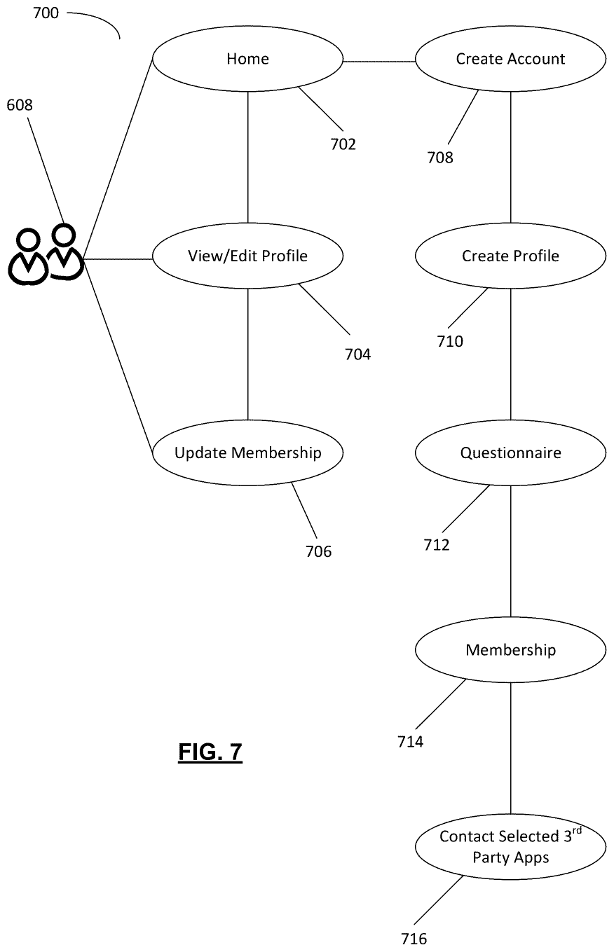

FIG. 7 depicts an embodiment of a system and method of user interaction 700. In the embodiment depicted in FIG. 7, the system and method can comprise a home module 702, a view/edit profile module 704, a membership module 706 which can be accessed and used by a user 608 if the user 608 has an account. In the event a user 608 does not have an account at the time the user 608 access the home module, a user can create an account 708, create a profile 710, provide responses to a questionnaire 712, access a membership module 714 and connect with a prescribed list of third-party apps 716.

In operation, a user 608 can create an account having a username and password and/or provide any other known, convenient and/or desired information. Any/all of such data can be stored in a database 604. In creation 710 or editing 704 of a profile, a user can respond to one or more prescribed questions and provide information, any/all of which data can be stored in a database 604 in/using any known, convenient and/or desired data structure and/or schema.

In some embodiments, depending on previous responses and choices, a user can be presented in a series of questions in the questionnaire module 712 and responses can be stored in a database 604 in/using any known, convenient and/or desired data structure and/or schema.

In the membership module 714, information regarding subscriptions to either the present application and/or third-party applications can be stored in a database 604 in/using any known, convenient and/or desired data structure and/or schema.

In the 3^{rd} party applications module 716, information regarding third-party application access information, data formatting and/or APIs can be stored in a database 604 in/using any known, convenient and/or desired data structure and/or schema.

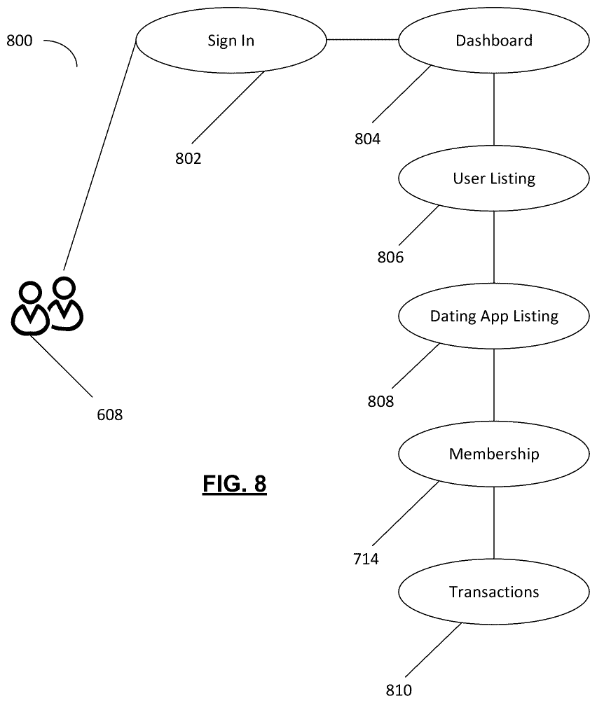

FIG. 8 depicts an embodiment of a system and method of user interaction 800. In the embodiment depicted in FIG. 8, a user 608 can sign in in module 802 and after login be presented with a dashboard 804. In some embodiments a dashboard 804 can provide overview information regarding the user's status and any updated information for 3^{rd} party applications. In the embodiment depicted in FIG. 8, the user listing module 806 can present and allow a user to view information that have provided to the present application and the dating app listing module 808 can present the user 608 with information as it will be presented in in a 3^{rd} party dating app and/or allow a user 608 to select, subscribe to, deselect and/or unsubscribe from various identified 3^{rd} party applications.

In the membership module 714, a user can select, subscribe to, deselect and/or unsubscribe from various identified 3^{rd} party applications and/or update services in the present application. Moreover, in the transactions module 810, a user can view any transaction history associated with the present application and/or 3^{rd} party applications.

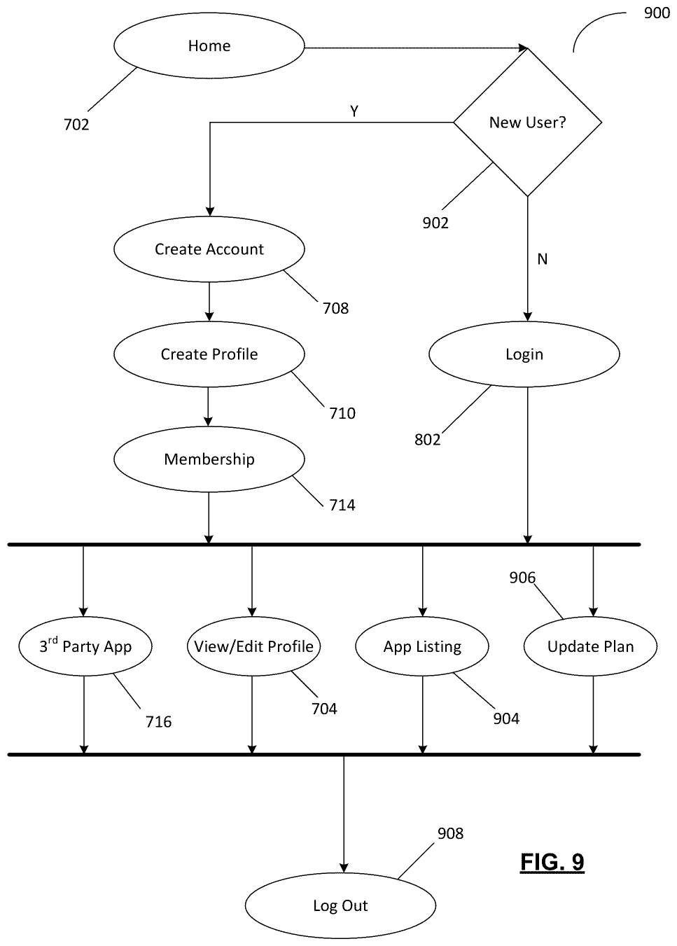

FIG. 9 depicts an embodiment of a system and method of user interaction 900. In the embodiment depicted in FIG. 9, after a user accesses a home module 702, it can be determined whether a user a new user or an existing user in step 902. If the user is an existing user, the user can be directed to login in step 802. If the user is a new user, the user can be directed to create an account 708, create a profile 710 and directed to the membership module 714.

After creation of an account or accessing an existing account, a user can access 3^{rd} party apps 716, view/edit a profile 704, review/create app listings 904 associated with 3^{rd} party apps and/or update plan options 906. In step 908 as user can log out of the system 900.

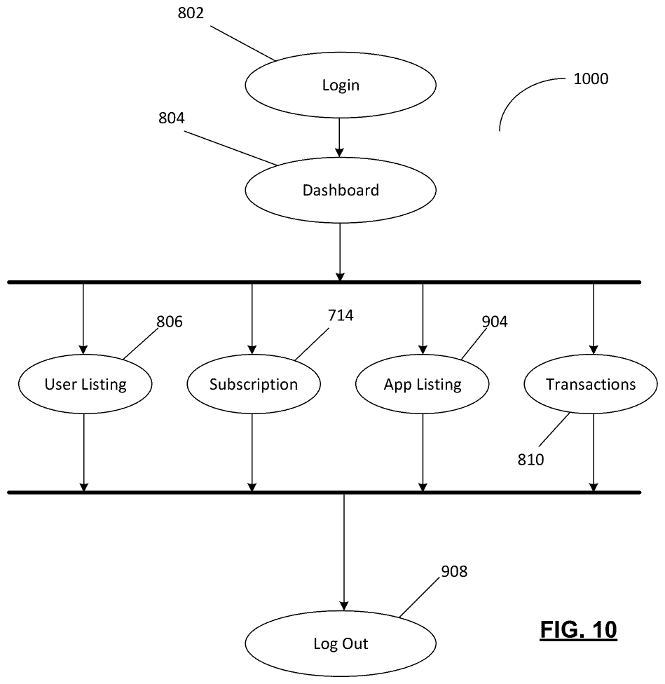

FIG. 10 depicts an embodiment of a system and method of administrative user interaction 1000. In the embodiment depicted in FIG. 10, the system and method can comprise the a login module 802, a dashboard module 804 wherein the dashboard module facilitates an administrative user's access to the user listing module, the subscription/membership module 714, the application listing module 904 and the transactions module 904 and enables an administrative user log out via module 908. In operation the system and method depicted in FIG. 10 facilitates an administrative user's access to a user's profile.

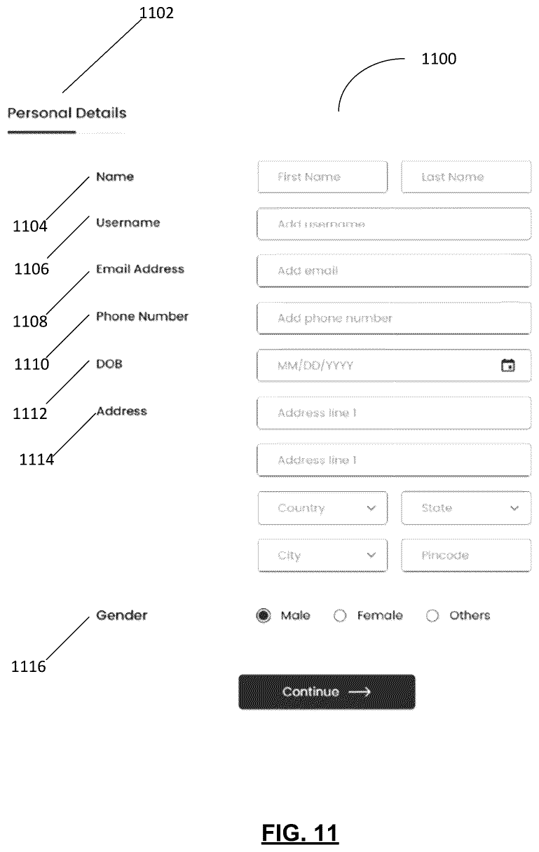

FIG. 11 depicts an embodiment of a user interface 1100. In the embodiment depicted in FIG. 11, a user can provide and/or edit/update personal details 1102. In some embodiments, personal details 1102 can comprise a user's name 1104, a username 1106, a user's e-mail address 1108, a user's phone number 1110, a user's date of birth 1112, a user's address 1114, a user's gender 1116 and/or any other known, convenient and/or desired information.

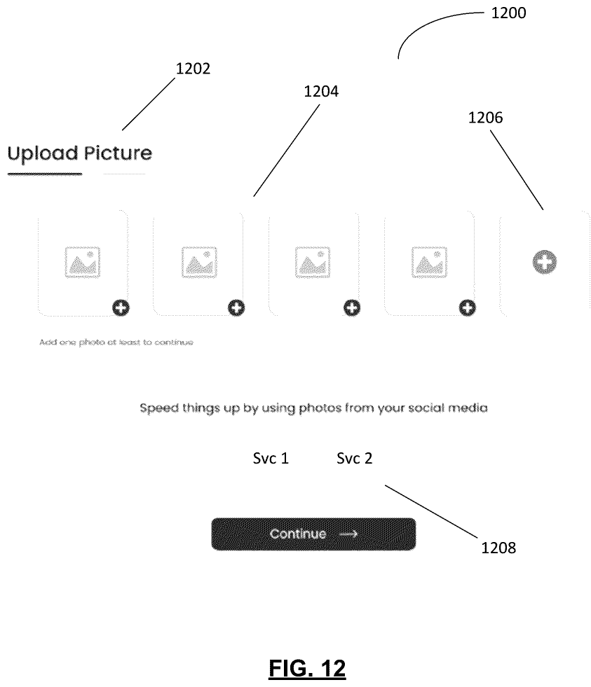

FIG. 12 depicts an embodiment of a user interface 1200. In the embodiment depicted in FIG. 12, a user can upload and/or edit/update pictures 1202. In some embodiments, the upload picture module 1200 can comprise uploaded pictures 1204 and a link to upload/add additional pictures 1206. In some embodiments, the upload picture module 1200 can comprise links to one or more social media platforms 1208 to facilitate retrieval of photographs from such social media platforms.

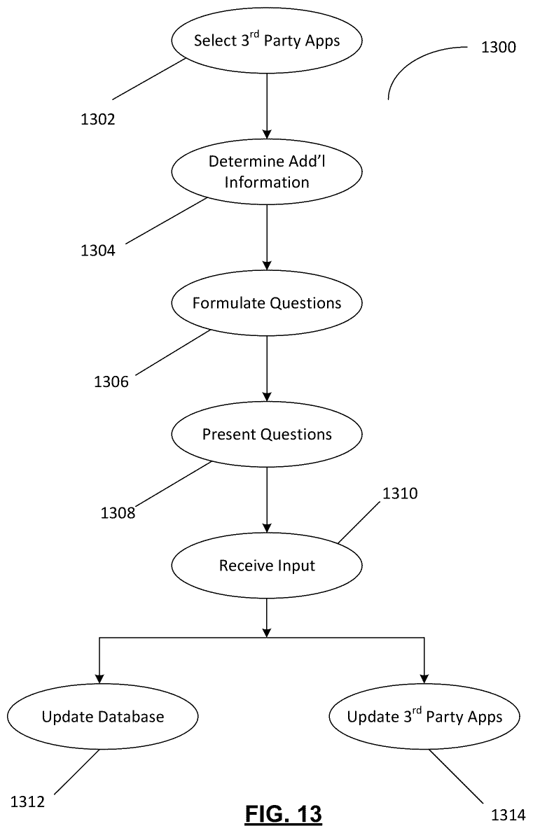

FIG. 13 depicts an embodiment of a system and method of user interaction 1300. In the embodiment depicted in FIG. 13, a user can select desired 3^{rd} party applications with which the present application is intended to cooperate in module 1302. Based on the user selected 3^{rd} party applications, the system can determine additional information required and/or desired by the 3^{rd} party applications in step 1304 and formulate questions 1306 to be presented and answered by the user in step 1308. In step 1310 a user can input information in response to the presented question for step 1308. Then in steps 1312 and 1314, the database 604 can be updated in step 1312 and the information received in step 1310 can be updated to the connected 3^{rd} party apps in step 1314.

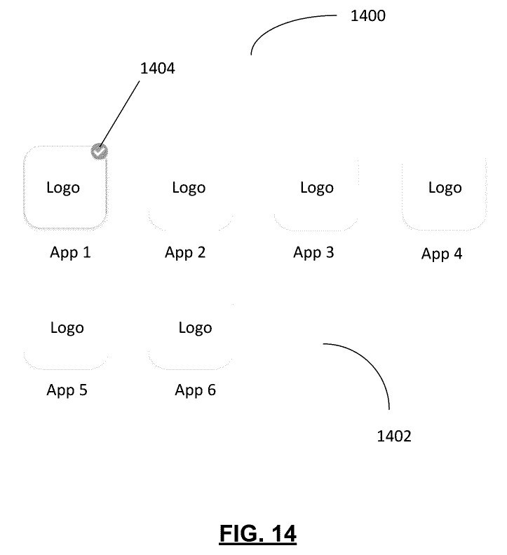

FIG. 14 depicts an embodiment of a user interface 1400. The embodiment depicted in FIG. 14, facilitates a user's selection of 3^{rd} party applications with which the present system and method can interact. In the embodiment depicted in FIG. 14, prescribed and supported 3rd party applications for integration 1402 can be identified, in some embodiments by name and/or logo and an indicator 1404 can indicate whether the 3^{rd} party application has been selected by the user. In operation, a user can select a desired 3^{rd} party application 1402 and select or deselect integration with such.

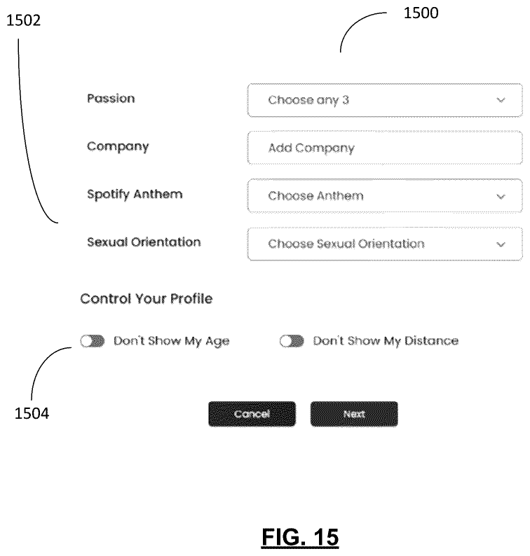

FIG. 15 depicts an embodiment of a user interface 1500. In the embodiment depicted in FIG. 15, a user 608 can be presented with questions 1502 related to one or more selected 3^{rd} party applications 1402. Additionally, in some embodiments, a user 608 can select options related to information which is available in such 3^{rd} party applications 1402.

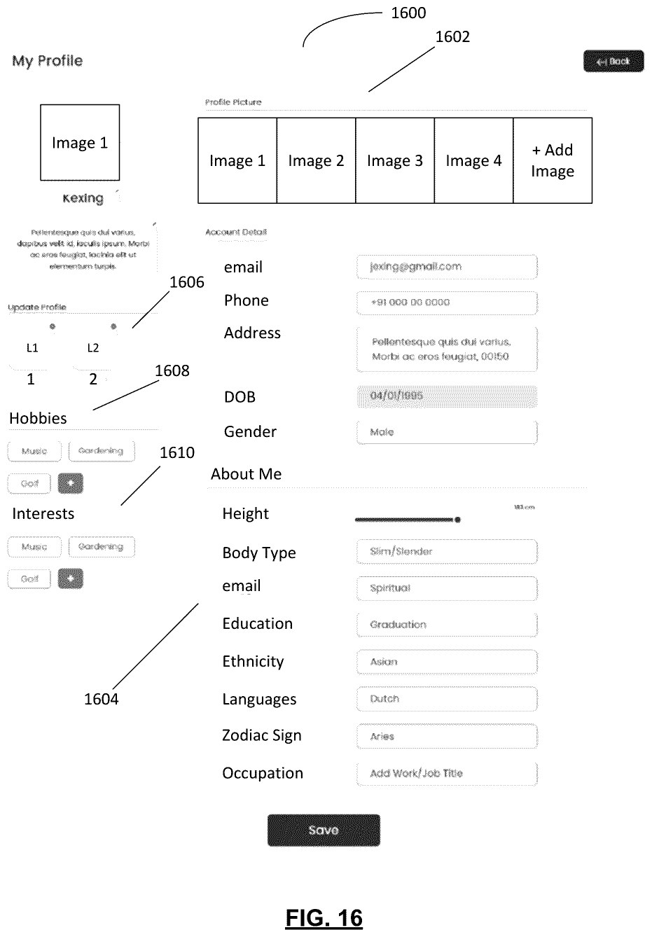

FIG. 16 depicts an embodiment of a user interface 1600. In the embodiment depicted in FIG. 16, a user can manipulate information contained within their profile, such as images 1602, information about the user 1604, integrations with 3^{rd} party applications 1606, and/or any other know convenient and/or desired information such as hobbies 1608 and interests 1610.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed:

1. A system comprising:
first memory adapted and configured to store information and data regarding a user in a plurality of first data fields;
communications components adapted and configured to interface with a plurality of alternate systems having second data fields corresponding to said first data fields;
identifying relationships between said first data fields and said second data fields;
automatically propagating data from said first data fields to said second data fields up receipt of a user request.
